(19) United States
(12) Patent Application Publication
(10) Pub. No.: US 2003/0174590 A1
(43) Pub. Date: Sep. 18, 2003

(54) Push button structure and an electronic device and timepiece having the same

(76) Inventors: Yasuo Arikawa, Chino-Shi (JP); Imao Hiraga, Chino-Shi (JP); Takumi Oshio, Shiojiri-Shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/243,100

(22) Filed: Sep. 13, 2002

(30) Foreign Application Priority Data
Mar. 14, 2002 (JP) 2002-70872

(51) Int. Cl. G04B 29/00

(52) U.S. Cl. 368/319

(57) ABSTRACT

A push button structure reduces the manufacturing cost as well as thickness by improving the configuration of functional parts of the push button structure. A pipe is fixed in a through-hole of an external case, and the shaft of an operating member is inserted slidably to the pipe. A cylindrical flexible member is held between the pipe and the crown of the operating member.

### BACKGROUND OF THE INVENTION

1. Field of the Invention

The present invention relates to a push button structure and an electronic device and timepiece having the same, and relates more particularly to a push button structure suitable for use in a portable timepiece or portable electronic device requiring a water-resistant construction.

2. Description of the Related Art

Conventional electronic devices such as clocks and watches commonly have push buttons for operating the device on a side of the external case (casing). This push button structure enables the operating member (button) to travel in and out relative to the external case. A structure such as described below and shown in FIG. 9 has conventionally been used to assure the water resistance of the external case.

As shown in FIG. 9 a cylindrical pipe 2 is welded in a through-hole 1a opened in the external case 1, and the shaft part 3a at the base of the operating button 3 is inserted into the pipe 2. An annular circumferential channel 3e is formed encircling the shaft part 3a, and a ring-shaped packing 4 is fit inside this circumferential channel 3e. A C-shaped retaining ring 5 is fit to the inside end part 3d of the shaft part 3a to prevent the button 3 from slipping outside the external case 1.

The diameter of the crown 3b of the button 3 is greater than the shaft part 3a, and an annular housing recess 3c is formed on the inside of an overhang extending around the circumference of the shaft part 3a. The outside end of a coil spring 6 is held inside this housing recess 3c, and the inside end of the coil spring 6 contacts a shoulder 2a formed to the pipe 2. The pipe 2 also has a flange 2b around the circumference thereof extending in the direction of the outside of the external case 1. The flange 2b is formed to encircle the crown 3b of button 3.

This push button structure is configured so that when the crown 3b of the button 3 is pushed in from the outside, the shaft part 3a moves to the inside of the external case 1, and the inside end part 3d of the button 3 contacts a contact spring or other member not shown in the figure on the inside of the external case 1. The contact spring movably deforms in conjunction with button 3 movement so as to open and close an electrical contact not shown in the figure.

### OBJECTS OF THE INVENTION

With the conventional push button structure used in a timepiece or other such electronic device it is difficult to process the inside surface of the through-hole 1a in the external case 1 to a smooth cylindrical surface. A pipe 2 is therefore welded inside the through-hole 1a so that the outside surface of the shaft part 3a of button 3 slides against the inside surface of the pipe 2. Water resistance is assured by the packing 4 where the outside surface of the shaft part 3a slides against the inside surface of the pipe 2. The problem is that because it is therefore necessary to form circumferential channel 3e around the shaft part 3a of button 3, part processing costs increase and the manufacturing cost increases.

Furthermore, because water resistance is conventionally assured using packing 4 where the outside surface of the shaft part 3a and the inside surface of the pipe 2 slide together, the pipe 2 must be long enough to contact the packing 4 throughout the full stroke of the button 3, and to assure sufficient water resistance between the packing 4 and the inside surface of the pipe 2, the packing 4 fit to the shaft part 3a of the button 3 also requires a certain length, more specifically, a length appropriate to the water resistance pressure. Because for these reasons the pipe 2 and button 3 require a sufficient length, the distance from the inside end to the outside end part of the button 3, that is, the thickness of the push button structure, cannot be reduced, and the button 3 projects greatly to the outside of the external case 1. If this push button structure is used in a device requiring an aesthetically appealing design, such as a wristwatch for example, it is difficult to achieve a pleasing design because of the large projection of button 3.

The present invention is therefore directed to solving the above problems, and an object of the invention is to provide a push button structure enabling both manufacturing cost and thickness to be reduced by improving the structure of functional parts of the push button structure.

A further object is to provide a structure able to assure the water resistance of the device even though the thickness of the push button structure is reduced.

A yet further object is to provide a push button structure with good operability.

### SUMMARY OF THE INVENTION

To solve the problems described above a push button structure according to the present invention is a push button structure having a stationary structure part and an operating member disposed protrudably to the stationary structure part, the operating member having a sliding part configured slidably to the stationary structure part and an operating crown connected on the outside of the sliding part and having an overhang configuration larger in diameter than the sliding part with a cylindrical, elastically deformable flexible member held between the overhang part of the operating crown and the stationary structure part and encircling the sliding part.

This invention can thus be configured so that a seal is assured between the stationary structure part and operating member by the cylindrical flexible member held between the overhang part of the operating crown and the stationary structure part. Therefore, because good lubricity and a seal can be assured between the sliding part of the operating member and the flexible member by only processing the outside surface of the sliding part to be smooth, the parts processing cost can be reduced. Furthermore, because it is not necessary to provide packing or other intervening flexible member in the sliding contact area between the sliding part of the operating member and the stationary structure part, the thickness of the stationary structure part can be reduced.

It should be noted that this stationary structure part of the invention is the part that is stationary when the operating member is moved in and out, and is equivalent to the external case 1 and pipe 2 of the prior art example described above. Furthermore, the operating member is the part that is pressed and the parts operating integrally thereto, and is equivalent to the button 3 in the prior art example described above. In addition, the flexible member can be any member that is elastically deformable in conjunction with the in and out operation of the operating member and can assure a seal between the stationary structure part and operating member, and packing materials used for seals, such as fluororubber, nitrile rubber, butyl rubber, and other synthetic rubber materials, can be used for the flexible member. Fluororubber is best suited in order to improve durability and water resistance.

In a preferred push button structure according to the present invention a shoulder part having a first surface part facing the sliding direction of the sliding part and a second surface part substantially opposing the sliding part is disposed to the stationary structure part, the flexible member has a cylindrical seal area with an axial-direction protrusion protruding toward the first surface part in a no-load state and a radial-direction protrusion protruding toward the sliding part opposing the second surface part, and the seal area is fit into the shoulder part.

Because the axial-direction protrusion is pressed by the holding force to the first surface part of the stationary structure part and the radial-direction protrusion constrained by the second surface part on the back is pressed to the sliding part in the seal area of the flexible member held between the overhang part of the operating crown and the stationary structure part, the performance of the seal formed by this seal area between the stationary structure part and the sliding part can be improved by this aspect of the invention. Sufficient water resistance can therefore be assured even if the operating force of the operating member is light and soft.

Further preferably, the push button structure of this invention is configured so that when the operating member is depressed to a position at which a desired operation ends, the fill ratio of the flexible member to a cylindrical space enclosed by a surface of the stationary structure part, a surface of the operating member, and the outside surface in the radial direction of the flexible member is in the range of 90% to 100%. Because the fill ratio of the flexible member elastically deformed in this cylindrical space is 90% to 100% when the operating member is depressed and slides to a position at which a desired operation is completed, sufficient operating member restoring force can be assured by the flexible member, a separate spring member is made unnecessary, unnecessary space inside the push button structure is reduced, and the thickness of the push button structure can therefore be made thin even while assuring the necessary operating stroke.

The push button structure of this invention further preferably has a housing recess formed around the sliding part inside the overhang part of the operating crown, and the flexible member has a contact part contacting the overhang part with an allowance in the radial direction inside the housing recess when the operating member is not pressed.

By thus disposing the contact part of the flexible member with space in the radial direction inside the housing recess in the overhang part of the operating crown, the part of the flexible member proximal to the contact part can be easily elastically deformed when the flexible member is elastically deformed by pressing on the operating member, and an even softer operating touch can be achieved.

Further preferably, the contact part is flange shaped in a push button structure of this invention. By thus forming a flange-shaped contact part, the rigidity of the contact part in the housing recess can be improved, the state and shape of the contact can be stabilized, and the direction and other aspects of elastic deformation in the neighborhood of the contact part can be stabilized.

Further preferably, the push button structure of this invention has a channel able to house an outside edge part of the outside of the housing channel in the operating crown formed in the stationary structure part. By thus forming in the stationary structure part a channel for housing an outside edge part on the outside of the housing channel, the thickness of the push button structure can be reduced while also assuring the operating stroke of the operating member.

Further preferably, the push button structure of this invention has an inclined cylinder part disposed to the flexible member between a first contact part contacting the inside of the overhang part and a second contact part contacting the stationary structure part.

Further preferably, the flexible member is configured to produce elastic force contributing to an operating member restoring operation in response to a pressing operation. By thus being configured so that the flexible member elastically deforms when the operating member is pressed and this elastic deformation produces a restoring force contributing to the restoring operation of the operating member, the push button structure can be configured without using separate metal springs or other such members, the number of parts can therefore be reduced, and an operating member with a soft touch can be achieved. With this means, however, it is sufficient for the elastic force of the flexible member to only contribute to the restoring operation of the operating member, and a separate flexible member (such as a metal spring) can be provided to reliably restore the operating member to the original position.

Further preferably, a through-hole in which the sliding part is slidably inserted is formed in the stationary structure part. There are cases in which a through-hole to which the sliding part is slidably inserted is formed in the stationary structure part. By slidably inserting the sliding part to a through-hole formed in the stationary structure part, internal mechanisms and contact mechanisms can be operated with the inside end part of the sliding part introduced to the inside of the stationary structure part.

Yet further preferably, a cylindrical guide member (equivalent to the above-noted pipe) is inserted and fixed in the through-hole, and the sliding part is inserted slidably to the inside of the guide member.

An electronic device according to the present invention has a push button structure as described above. Examples of such electronic devices include radio receivers, television receivers, cordless telephones, computer devices, diving computers, and electronic timepieces.

A timepiece according to the present invention has a push button structure as described above. Examples of such timepieces include wristwatches, pocket watches, and other portable timepieces, mantle clocks, and various other types of timepieces.

Using the push button structure of this invention as a switch mechanism for a portable timepiece or portable electronic device is an effective way to reduce the case thickness, improve operability, and improve the exterior design. Such switches can be used to select, run, stop, start, pause, reset, adjust, or otherwise manipulate various functions. Examples of such functions include a time display, calendar display, stopwatch, timer, alarm, or illumination.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1 is an enlarged partial section view of a push button structure according to a first embodiment of the present invention.

FIG. 2 is an enlarged section view showing the push button structure according to the first embodiment when the button is depressed.

FIG. 3 is an enlarged partial section view of a push button structure according to a second embodiment of the present invention.

FIG. 4 is an enlarged partial section view of a push button structure according to a third embodiment of the present invention.

FIG. 5 is an enlarged partial section view of a push button structure according to a fourth embodiment of the present invention.

FIG. 6 is an enlarged partial section view of a push button structure according to a fifth embodiment of the present invention.

FIG. 7 is an enlarged partial section view of a push button structure according to a sixth embodiment of the present invention.

FIG. 8 is a longitudinal section view showing the structure of the body of a portable timepiece applying the push button structure of the present invention.

FIG. 9 is an enlarged partial section view of a conventional push button structure.

### DESCRIPTION OF THE PREFERRED EMBODIMENTS

Preferred embodiments of a push button structure according to the present invention and an electronic device and timepiece having this push button structure are described below with reference to the accompanying figures.

### Embodiment 1

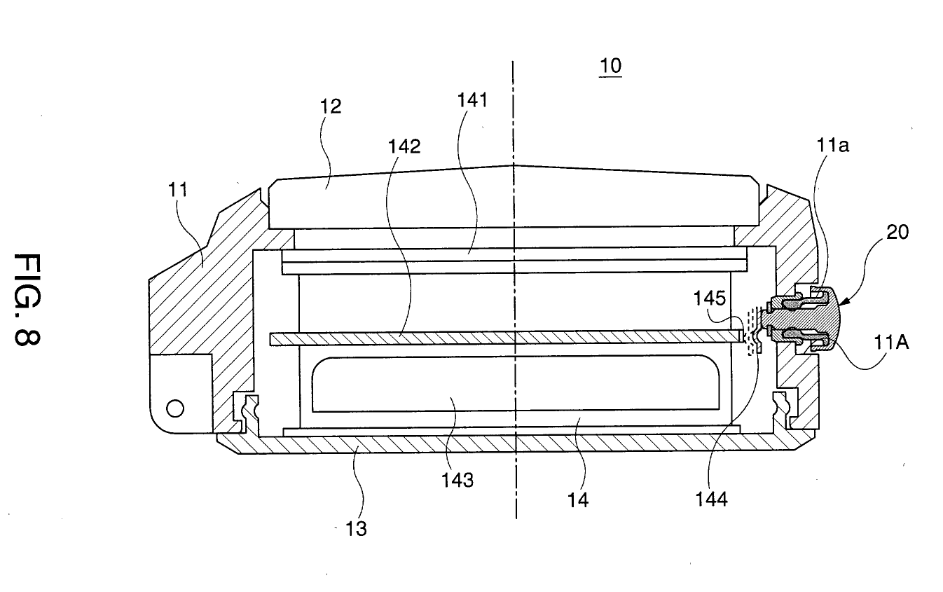

FIG. 8 is a longitudinal section view showing a typical timepiece body 10 of a portable timepiece having a push button structure according to this embodiment of the invention. The part on the left side of the dot-dash line in the middle shows a section view in the 12 o'clock direction and 6 o'clock direction of the timepiece body, and the part on the right side of the dot-dash line shows a section in the 3 o'clock direction of the timepiece body. The timepiece body 10 has an external case 11, display glass 12 mounted to the front side of the external case 11, a back cover 13 mounted to the back side of the external case 11, and a movement 14 housed inside the external case 11. The movement 14 has a display unit 141 such as hands or an liquid crystal panel, a circuit board 142, and a power source 143 such as a normal battery, voltaic cell, or high capacitance capacitor.

Stainless steel, titanium alloy, gold alloy, or other metal material, or a plastic such as polycarbonate or ABS is used for the external case 11.

A contact spring 144 is disposed to the movement 14, and is positioned opposite a terminal pad 145 of the circuit board 142. The contact spring 144 is, for example, formed as part of a presser plate disposed inside the movement 14. The contact spring 144 is elastically deformable, and is configured so that it can contact the terminal pad 145 as a result of this elastic deformation.

A through-hole 11a is formed passing through the case inside to outside on the side (the side in the 3 o'clock direction) of the external case 11. An enlarged recess 11A with a diameter greater than the through-hole 11a is formed on the outside of the through-hole 11a, and the push button structure 20 described below is configured inside the through-hole 11a and enlarged recess 11A.

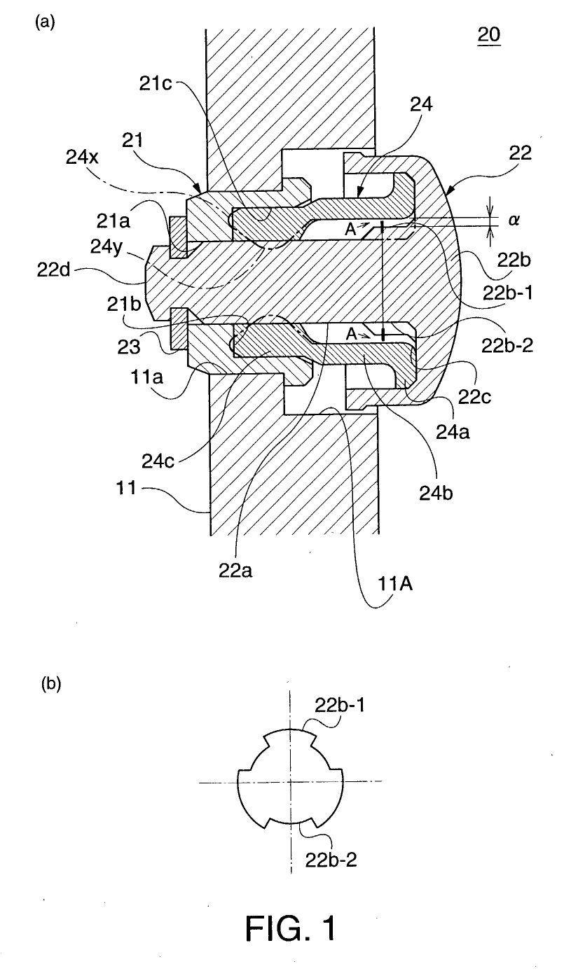

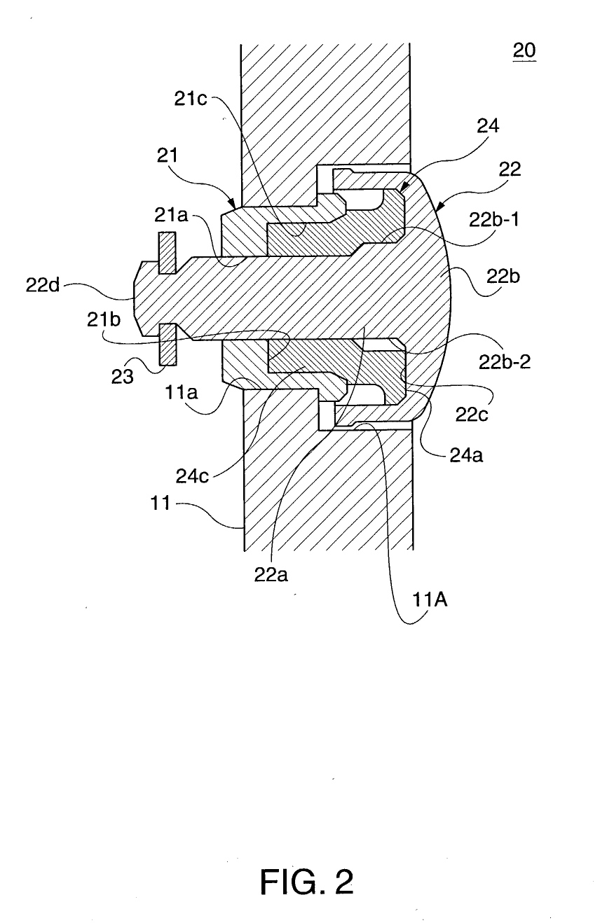

FIG. 1(a) is an enlarged partial section view of the push button structure 20 according to the present invention, and FIG. 1 (b) is a section view of push button structure 20 through line A-A of FIG. 1A. FIG. 2 is an enlarged section view showing the operating member (button) 22 of this push button structure 20 in the depressed position. A pipe 21 is inserted into through-hole 11a and fixed to the external case 11 by welding, for example, in this push button structure 20.

Disposed on this pipe 21 are a cylindrical inside surface part 21a formed on the inside of the external case 11, a first surface part 21b and a second surface part 21c. The first surface part 21b is a ring-shaped flat surface facing the outside adjacent to the outside of this inside surface part 21a, and second surface part 21c is a cylindrical inside surface adjacent to the outside circumference side of the first surface part 21b. Stainless steel, titanium alloy, or other metal material is used for the material of the pipe 21.

Disposed on the operating member 22 are a columnar shaft part 22a (equivalent to the above-noted sliding part) slidably inserted to the pipe 21 and sliding in contact with first surface part 21b, and an umbrella-shaped crown 22b (equivalent to the above-noted operating crown) formed with a larger diameter overhanging the circumference of the end of the shaft part 22a. A C-shaped retaining ring 23 is fit to the inside end part 22d of the shaft part 22a, and by engaging the inside end of the pipe 21 prevents the operating member 22 from slipping out of the external case 11. An annular housing recess 22c encircling the shaft part 22a is formed on the inside of the overhang part of the crown 22b. Part 22b-2 is formed to all or part of the circumference around the axis at the inside inside-circumference surface 22b-1 of the housing recess 22c.

The maximum height Rmax of the surface roughness of the finished surface of the part of shaft part 22a contacting flexible member 24 is preferably finished to 3.2 μm or less when specified according to JIS B0601, and further preferably is finished to a mirror surface. If the maximum height Rmax of this surface roughness is 3.2 μm or greater, the friction coefficient of flexible member 24 and shaft part 22a increases, lubricity drops, and a strong operating force becomes necessary. Water resistance defects can also occur easily because adhesion between the flexible member 24 and shaft part 22a is degraded.

Because the friction coefficient can be reduced by coating the contact surfaces of the flexible member 24 and shaft part 22a with silicone oil, lubricity improves, push button operability improves, and water resistance can be improved. More particularly, this improves water resistance when the push button is depressed, and suppresses water resistance failures during circuit operation.

A flexible member 24 made of synthetic rubber, for example, is held between the first surface part 21b of pipe 21 and the overhang part of the crown 22b of operating member 22. Overall this flexible member 24 has a cylindrical shape with a flange-shaped outside end contact part 24a contacting the inside bottom surface of housing recess 22c disposed to the overhang part of the crown 22b, middle part 24b configured in a cylindrical shape extending in the axial direction from the outside end contact part 24a, and a seal part 24c fit inside the space (“packing box” below) enclosed by the first surface part 21b and second surface part 21c of pipe 21 and the outside surface of shaft part 22a of operating member 22.

The maximum height Rmax of the surface roughness of the finished surface of the part of second surface part 21c contacting flexible member 24 is preferably finished to 3.2 μm or less when specified according to JIS B0601, and further preferably is finished to a mirror surface. Because the friction coefficient of flexible member 24 and shaft part 22a increases and lubricity drops if the maximum height Rmax of this surface roughness is 3.2 μm or greater, frictional force increases, operability deteriorates, and water resistance deteriorates. However, coating the part of second surface part 21c contacting flexible member 24 with silicone oil can reduce the friction coefficient, thereby improving lubricity, improving push button operability, and improving water resistance.

When not depressed (the state shown in FIG. 1) the outside end contact part 24a contacts the housing recess 22c with room in the radial direction. That is, the width of the outside end contact part 24a in the radial direction is smaller than the width of the housing recess 22c in the radial direction. Yet more specifically, in the example shown in the figure, a space α is present between the outside end contact part 24a and the inside inside-circumference surface 22b-1 of the housing recess 22c.

In a no-load state (a state in which stress other than atmospheric pressure is not applied to the flexible member 24), the sectional shape around the longitudinal axis of seal part 24c is as shown by the dot-dash line in FIG. 1(b). This sectional shape has an axial-direction nodule 24x protruding toward the first surface part 21b, and a radial-direction nodule 24y protruding in the direction of the outside surface of shaft part 22a opposite second surface part 21c.

Having a sectional shape as thus described in a no-load state, the flexible member 24 is held in a slightly compressed condition between the overhang part of crown 22b and the first surface part 21b of pipe 21, and is elastically deformed such that axial-direction nodule 24x (FIG. 1) and radial-direction nodule 24y are flattened by being fit in a compressed state between the second surface part 21c of pipe 21 and the outside surface of shaft part 22a of operating member 22 and the flexible member 24 fills the packing box enclosed by the outside surface (first surface) part 21b and opposing inside surface (second surface) part 21c and the outside surface of shaft part 22a.

When the crown 22b of operating member 22 is pressed in this push button structure 20, flexible member 24 is pressed and compressed in the axial direction, shaft part 22a slides to the inside of external case 11, and inside end part 22d thereof protrudes inside the case. The contact spring 144 shown in FIG. 8 is thus pressed by the inside end part 22d and contacts terminal pad 145 of circuit board 142.

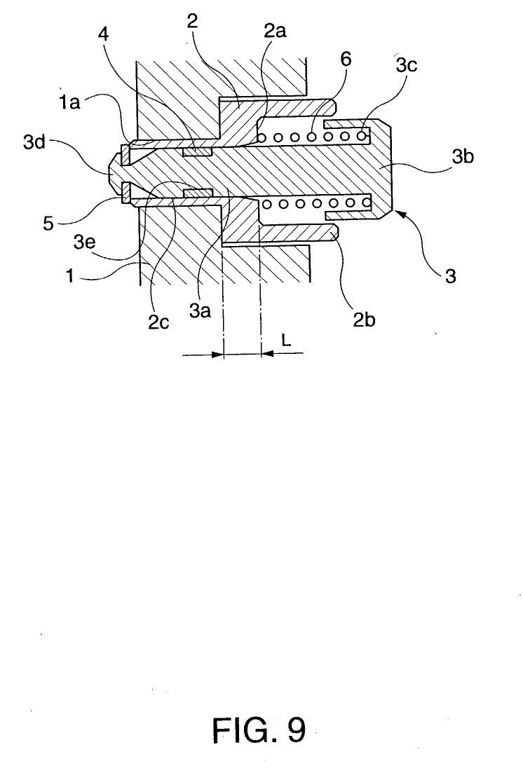

Returning to FIG. 8, when the operating member 22 is depressed to the position where the desirable operation of the contact spring 144 contacting terminal pad 145 is completed, flexible member 24 (FIG. 2) is elastically deformed to substantially fill the space enclosed by first surface part 21b and second surface part 21c of pipe 21, the inside surface of housing recess 22c, the outside surface of shaft part 22a, and the partially exposed outside surface of flexible member 24. The fill ratio of the flexible member 24 to this space is in the present embodiment designed to be within 90% to 100% of the available space. Because sufficient restoration force can be assured for the operating member 22 when pressure on the crown 22b of the operating member 22 is released by thus setting the fill ratio within this range, the need to use another spring member to return the operating member 22 to the original position can be eliminated and the push button structure can be compactly configured while assuring the operating stroke of the operating member 22, and as a result the thickness of the push button structure (the length in the axial direction, that is, the length in the right to left direction as seen in the figure) can be reduced. More specifically, because the length L in FIG. 9 can be shortened, the thickness of the button structure can be reduced. It is therefore possible to provide a watch with a slim design.

The inside circumference surface 21c-1 of housing recess 22c may be normally formed to a constant diameter throughout in the present embodiment, but all or part of the circumference can be formed with a small diameter to a contour as shown by part 22b-2 in the figure. By forming a contour as indicated by part 22b-2 to all or part of the circumference, the repulsive force of the flexible member 24 required for button operation can be adjusted. More specifically, by providing this part 22b-2 an area not filled with flexible member 24 can be formed in at least part on the outside circumference side thereof even when the button is depressed as shown in FIG. 2, and the fill ratio will therefore be less than 100%. The fill ratio can therefore be adjusted by the presence or absence of part 22b-2 and where and how deep part 22b-2 is formed, and the elastic repulsion force of the flexible member 24 when the button is pressed can be adjusted by thus adjusting the fill ratio. In particular, by forming part 22b-2 in part in the axial direction or circumferential direction around the axis, the fill ratio can be set appropriately without greatly disturbing the basic shape of the flexible member 24 when the button is pressed. Because a sufficient design margin can be assured in the position of the operating member 22 when pressed and the stress required to elastically deform the flexible member 24 can be reduced for the same reason, the operating force of the operating member 22 is reduced and the button can be operated with soft tactile response.

By forming the outside end contact part 24a of flexible member 24 so that there is a space in the radial direction (up and down as seen in the figure) to the housing recess 22c when the operating member 22 is not depressed, there is allowance for elastic deformation near the outside end contact part 24a when the operating member 22 is not pressed as shown in FIG. 2, and the tactile response of the operating member 22 can be made even softer. It should be noted that the outside end contact part 24a has allowance in the radial direction to the housing recess 22c to stabilize the elastic deformation state of the flexible member 24, and the outside end contact part 24a is preferably designed to elastically deform as shown in FIG. 2 so as to completely fill the housing recess 22c in the radial direction when the operating member 22 is pressed and the operating member 22 moves to the position at which a desired operation is completed.

Because the outside end contact part 24a is flange shaped in the present embodiment, the rigidity of the outside end contact part 24a can be increased, and the elastic deformation of the outside end contact part 24a can be stabilized when the operating member 22 is depressed. That is, because when the button is pressed and the flexible member 24 is compressed in the axial direction, the curved part between the middle part 24b and flange-shaped outside end contact part 24a gradually elastically deforms and gradually spreads in the radial direction with the outside end contact part 24a in contact with the inside surface of the housing recess 22c, and the elastic deformation state of the outside end contact part 24a is resistant to change even after being repeatedly depressed. It is therefore possible to maintain stable operability and restoring force.

Because axial-direction nodule 24x and radial-direction nodule 24y are formed to seal part 24c of flexible member 24 as shown in FIG. 1 in the present embodiment, the seal part 24c will be sufficiently compressed in both the axial direction and radial direction, and the seal between the pipe 21, which is a part of the stationary structure part, and the shaft part 22a of operating member 22 can be improved. In particular, even with repeated elastic deformation of the flexible member 24 each time the operating member 22 is pressed as described above, there is little effect on the seal performance of the seal part 24c, and sufficient water resistance can be assured for a wristwatch. It should be noted here that while the axial-direction nodule 24x and radial-direction nodule 24y formed on the flexible member 24 each have one nodule in FIG. 1, a plurality of nodules 24x can be formed. A plurality of radial-direction nodules 24y could also be formed. Furthermore, water resistance can be likewise assured when these nodules of the flexible member 24 are disposed to the second surface part 21c of the pipe 21.

### Embodiment 2

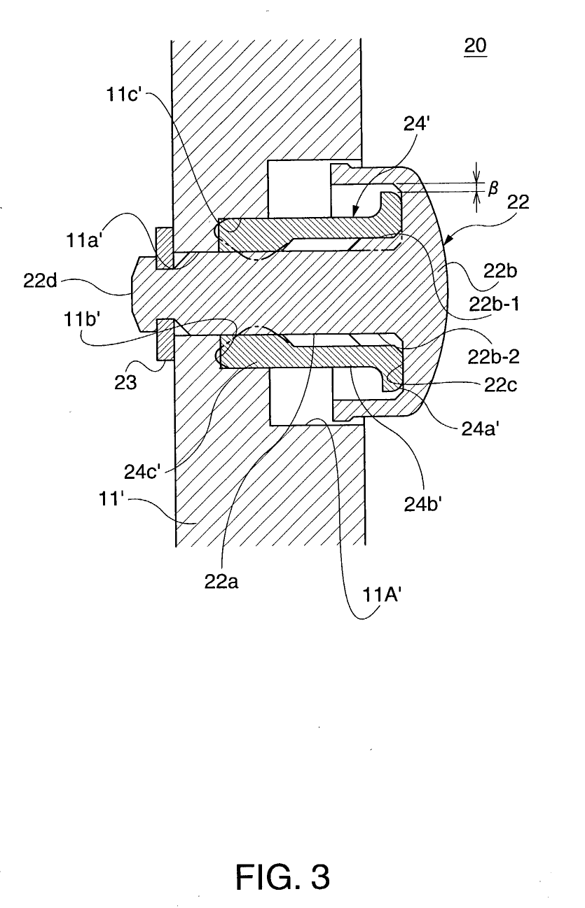

A second embodiment of the present invention is described below with reference to FIG. 3. The operating member 22 and retaining ring 23 in this embodiment are identical to those in the first embodiment, are therefore identified by the same reference numerals, and further description thereof is omitted below.

The pipe 21 of the first embodiment is not fixed to the external case 11′ in this embodiment, and operating member 22 is inserted directly to the through-hole 11a′. A ring-shaped flat first surface part 11b′ facing the axial direction, and a second surface part 11c′ that is a cylindrical inside surface facing the radial direction, are formed inside enlarged recess 11A′ directly to the external case 11′.

The flexible member 24′ has an outside end contact part 24a′, middle part 24b′, and seal part 24c′. As in the first embodiment the outside end contact part 24a′ is flange shaped projecting to the outside. The seal part 24c′ is fit into a space formed by first surface part 11b′, second surface part 11c′, and the outside surface of shaft part 22a of operating member 22.

When the operating member 22 is not pressed in this embodiment the outside end contact part 24a′ contacts the housing recess 22c with an allowance in the radial direction as in the first embodiment. Unlike in the first embodiment, however, the outside end contact part 24a′ contacts the inside inside-circumference surface of the housing recess 22c with a gap 3 formed between the outside end contact part 24a′ and the outside inside-circumference surface of the housing recess 22c.

The operating member 22 is thus directly inserted slidably to the through-hole 11a′ in external case 11′ without using an intervening pipe in this embodiment of the invention, but because the seal between the external case 11′ and operating member 22 is assured by the seal part 24c′ of the flexible member 24′ it is sufficient to make the outside surface of the shaft part 22a of operating member 22 smooth and the inside surface of the through-hole 11a′ does not require high precision polishing. The cost required for parts processing can therefore be reduced compared with the prior art.

Furthermore, while the point of contact between the outside end contact part 24a′ and housing recess 22c in this embodiment differs slightly from the first embodiment, the outside end contact part 24a′ contacts the housing recess 22c with allowance in the radial direction in the same way as in the first embodiment. The flexible member 24′ is therefore pressed and compressed by depressing the operating member 22 and the outside end contact part 24a′ and proximal parts spread in the radial direction, and substantially the same operation and effect as in the first embodiment are achieved.

### Embodiment 3

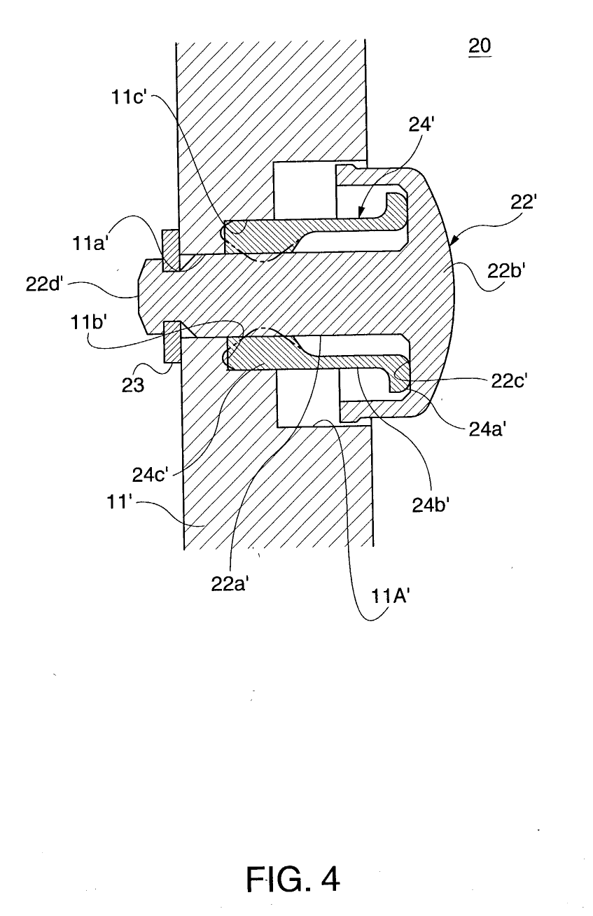

A third embodiment of the present invention is described next below with reference to FIG. 4. The push button structure of this embodiment is substantially the same as the push button structure of the second embodiment, like parts are therefore identified by like reference numerals, and further description thereof is omitted below.

This embodiment differs from the second embodiment in that the housing recess 22c′ of the operating member 22′ having shaft part 22a′ and crown 22b′ is formed wide toward the inside, and as a result the outside end contact part 24a′ of flexible member 24′ is separated from both the inside inside-circumference surface and the outside inside-circumference surface inside the housing recess 22c′. Because the outside end contact part 24a′ of flexible member 24′ thus contacts the housing recess 22c′ with an allowance to both the inside and outside in the radial direction, there is greater allowance for elastic deformation of the flexible member 24′ to the crown 22b′ of the operating member 22′ and the amount of elastic deformation proximal to the outside end contact part 24a′ of the flexible member 24′ can be increased. The operating stroke of the operating member 22′ can therefore be increased and the button can be operated with an even softer touch.

### Embodiment 4

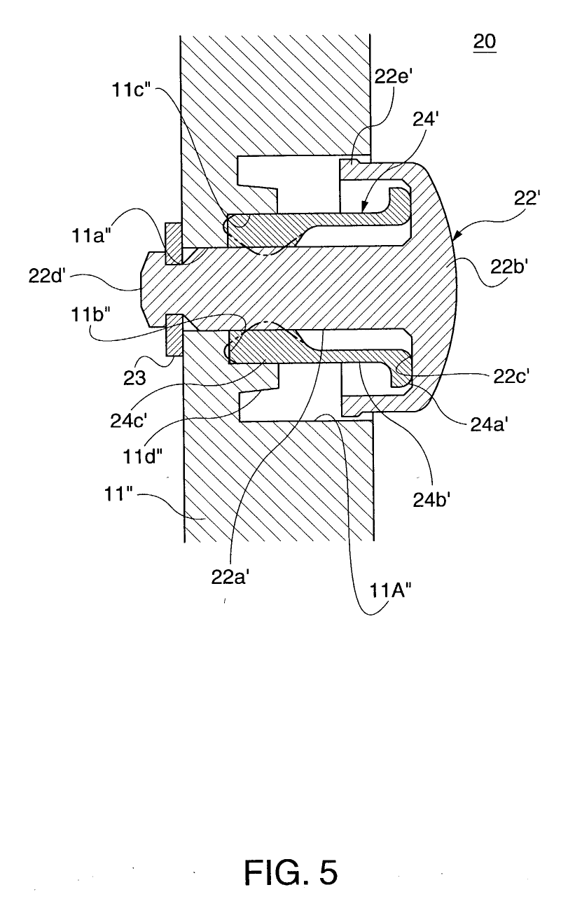

A fourth embodiment of the present invention is described next with reference to FIG. 5. The operating member 22′, retaining ring 23, and flexible member 24′ of this push button structure are identical to those of the third embodiment, like parts are therefore identified by like reference numerals, and further description thereof is omitted below.

Only the structure of the external case 11″ differs in the present embodiment from the third embodiment. In this embodiment an annular channel 11d″ is formed to external case 11″ inside the enlarged recess 11A″ formed on the outside of through-hole 11a″ and on the outside circumference side of where the first surface part 11b″ and second surface part 11c″ are formed. This channel 11d″ is formed to receive the circumferential edge part 22e′ on the outside circumference side of the housing recess 22c′ in the crown 22b′ of the operating member 22′.

Because a channel 11d″ for receiving the circumferential edge part 22e′ of the housing recess 22c′ is formed to the external case 11″ in this embodiment, the operating stroke of the operating member 22′ can be increased by the depth of the channel 11d″. It will be noted that the shape and dimensions of the flexible member 24′ must be designed appropriately to the operating stroke in this case.

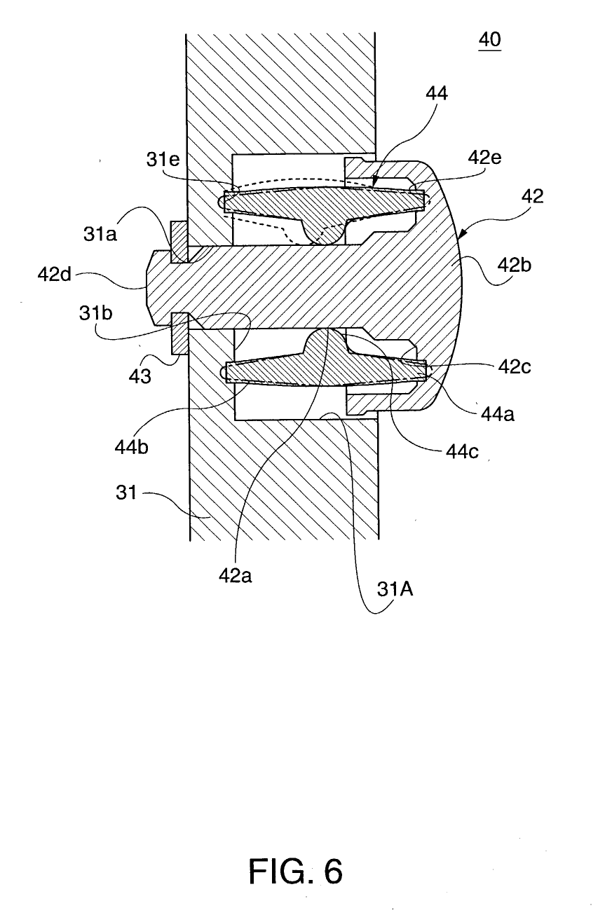

A push button structure 40 according to a fifth embodiment of the invention is described next with reference to FIG. 6. In this embodiment a through-hole 31a and enlarged recess 31A are formed in the external case 31, and the shaft part 42a of the operating member 42 is inserted slidably to the through-hole 31a. A retaining ring 43 as described above is fit to the inside end part of the shaft part 42a. A larger diameter crown 42b is formed on the operating member 42 with an annular housing recess 42c as described above formed on the inside of the overhang part of the crown 42b. A further annular channel 42e is formed in the inside surface of the housing recess 42c. An annular channel 31e substantially identical to channel 42e is formed in the enlarged recess 31A at a part opposite the housing recess 42c.

The flexible member 44 is substantially cylindrical with an annular first contact part 44a fit into channel 42e and an annular second contact part 44b fit into channel 31e formed at opposite, ends of the flexible member 44. A ring-shaped inside nodule 44c is formed extending flange-like to the inside between first contact part 44a and second contact part 44b with the inside edge of this inside nodule 44c pressed against the outside circumference surface of the shaft part 42a of operating member 42. The shape of the flexible member 44 in section when in a no-load state is shown by the dot-dash line in the figure.

When the operating member 42 is pressed in this embodiment of the invention the flexible member 44 is compressed as indicated by the dotted line in the figure between the housing recess 42c of crown 42b and the enlarged recess 31A of external case 31 such that restoring force is exerted on the operating member 42. Furthermore, the shaft part 42a slides against the inside nodule 44c formed so that it protrudes to the inside of the flexible member 44 in conjunction with movement of the operating member 42 in the axial direction when the operating member 42 is pressed, but because this inside nodule 44c is formed at substantially the midpoint in the axial direction of the flexible member 44 and the protrusion direction is orthogonal to the direction of operating member 42 movement, there is little change in the state of compression between the inside nodule 44c and shaft part 42a of operating member 42 due to pressing the flexible member 44.

The seal formed by flexible member 44 between external case 31 and operating member 42 in this embodiment is achieved by the insertion fitting of first contact part 44a to channel 42e, the insertion fitting of second contact part 44b to channel 31e, and the pressure point between the inside nodule 44c and the outside surface of the shaft part 42a of operating member 42.

### Embodiment 6

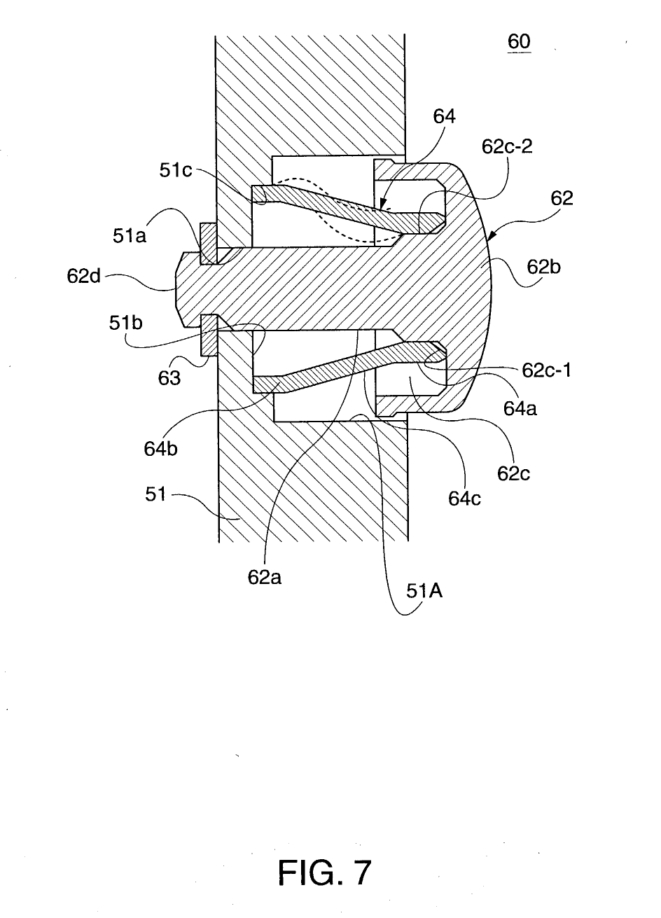

A push button structure 60 according to a sixth embodiment of the present invention is described last with reference to FIG. 7. In this embodiment a through-hole 51a is formed in external case 51 and an enlarged recess 51A is formed to the outside of this through-hole 51a. A shoulder with a second surface part 51c formed by a cylindrical inside surface opposing the outside circumference surface of the shaft part 62a of operating member 62 further described below is formed adjacent on the outside circumference side of a ring-shaped flat first surface part 51b in enlarged recess 51A.

As in each of the previous embodiments a crown 62b and shaft part 62a are disposed to the operating member 62, and a retaining ring 63 is fit to the inside end part 62d of shaft part 62a. A housing recess 62c as described above is formed to the crown 62b.

A cylindrically shaped flexible member 64 is held between the overhang part of crown 62b of operating member 62 and the inside of enlarged recess 51A. This flexible member 64 has a first contact part 64a contacting both the inside surface 62c-1 and inside inside-circumference surface 62c-2 of housing recess 62c disposed to crown 62b, and a second contact part 64b contacting both first surface part 51b and second surface part 51c. An inclined cylinder part 64c with a circular truncated cone shape having both inside diameter and outside diameter increasing gradually to the inside in the axial direction is disposed between the first contact part 64a and second contact part 64b.

When the operating member 62 is pressed in this embodiment the inclined cylinder part 64c of the flexible member 64 is elastically deformed inside and out as indicated by the dotted line in the figure. The operating member 62 is thus configured to receive restoring force from the flexible member 64. Furthermore, the sealing effect of the flexible member 64 is achieved by contact between the first contact part 64a and inside surface 62c-1 and inside inside-circumference surface 62c-2 of the housing recess 62c, and contact between the second contact part 64b and first surface part 51b and second surface part 51c of external case 51.

As described above, the flexible member in each embodiment of the present invention does not need to be housed in a circumferential channel 3e of the shaft part 3a as does the packing 4 shown in FIG. 9. Because the packing 4 in FIG. 9 must be pushed in while sliding along the outside surface of the shaft part 3a during assembly in order to seat it in the circumferential channel 3e of shaft part 3a, the outside surface of the packing 4 is subject to easy tearing and scratching. On the other hand, because such excessive pushing is not required when assembling the flexible member of the present invention, tears and scratches in the outside surface of the flexible member can be prevented. Water resistance is thus further improved.

The durability of push button operation is also improved with the present invention because circumferential channel 3e is eliminated. That is, when force acts perpendicularly to the axial direction of the push button in the example shown in FIG. 9 a bending moment acts on circumferential channel 3e, stress is thus easily concentrated and failure occurs easily.

Furthermore, because the flexible member in each embodiment of the present invention provides water resistance, has a restoring function for returning the push button to the original position, and has an integral shape, the length of dimension L in FIG. 9 can be shortened and the thickness of the button structure can be reduced. It is therefore possible to provide a timepiece or other electronic device with a slim design.

It should be noted that a push button structure, electronic device, and timepiece according to the present invention shall not be limited to the above-described examples shown in the figures, and various modifications and changes can be made without departing from the intended scope of the invention. For example, the push button structure shall not be limited to the side of the case and can be disposed to any desired position such as, for example, the top of the case, and the button 20 could be a push button structure substituted for the cover glass 12. Furthermore, in addition to timepieces the push button structure of the present invention can be applied to electronic devices such as portable telephones, calculators, and diving computers.

### Effect of the Invention

The present invention can, as described above, reduce manufacturing cost and device thickness. It can also improve the operability and water resistance of the push button structure.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A push button structure comprising:
a stationary structural part having shoulder section; and
an operating member disposed protrudably in the stationary structural part, the operating member having a sliding part configured to slide within the stationary structural part and an operating crown connected on the outside of the sliding part and having an overhang section larger in diameter than the sliding part; and
a cylindrical, elastically deformable flexible member held between the overhang section of the operating crown and the stationary structural part and encircling the sliding part; wherein
said shoulder section has a first surface part facing the sliding direction of the sliding part and a second surface part substantially opposing the sliding part; and
said flexible member includes a cylindrical seal area having an axial-direction protrusion protruding toward said first surface part in a no-load state and a radial-direction protrusion protruding toward said sliding part opposing the second surface part, said cylindrical seal area being fitted into the shoulder part.

2. A push button structure as described in claim 1, configured so that when the operating member is depressed to a predefined position, the fill ratio of the flexible member to a cylindrical space enclosed by a surface of the stationary structure part, a surface of the operating member, and the outside surface in the radial direction of the flexible member is in the range of 90% to 100%.

3. A push button structure as described in claim 1, further comprising:
a housing recess formed around the sliding part inside the overhang part of the operating crown; wherein
the flexible member has a contact part contacting the overhang part with an allowance in the radial direction inside the housing recess when the operating member is not pressed.

4. A push button structure as described in claim 3, wherein the contact part is configured to have a flange shaped.

5. A push button structure as described in claim 3, further comprising a channel for housing an outside edge part on the outside of the housing channel formed in the operating crown in the stationary structural part.

6. A push button structure as described in claim 1, further comprising an inclined cylinder part disposed on the flexible member between a first contact part contacting the inside of the overhang part and a second contact part contacting the stationary structural part.

7. A push button structure as described in claim 1, wherein the flexible member is configured to produce an elastic force contributing to an operating-member-restoring operation in response to a pressing operation.

8. A push button structure as described in claim 1, wherein a through-hole in which the sliding part is slidably inserted is formed in the stationary structural part.

9. A push button structure as described in claim 8, wherein a cylindrical guide member is fixed in an inserted position in the through-hole, and the sliding part is inserted slidably inside the guide member.

10. An electronic device comprising a push button structure as described in claim 1.

11. A timepiece comprising a push button structure as described in claim 1.
